(19) United States
(12) Patent Application Publication
(10) Pub. No.: US 2010/0064213 A1
(43) Pub. Date: Mar. 11, 2010

(54) Operation device for a graphical user interface

(76) Inventor: Zhou Ye, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,022

(22) Filed: Sep. 10, 2008

(51) Int. Cl. G06F 3/00

(52) U.S. Cl. 715/700

(57) ABSTRACT

An operation device for a graphical user interface includes an image sensing unit and a GUI. The image sensing unit includes an IR lighting device, an image obtaining device, and a calculation control module. The IR lighting device is used for emitting IR to the user. The IR reflected from the user pass through the image obtaining device, forms a photo image, and outputs a digital image signal. The calculation control module receives and calculates the digital image signal, and corresponds to the user's body motions to generate an operation signal. The GUI is connected with the image sensing unit and is displayed on a display screen. By using the operation signal generated form the image sensing unit, the user can use the body motion to control and operate the GUI.

### BACKGROUND OF THE INVENTION

1. Field of the Invention

The present invention relates to an operation device for a graphical user interface (GUI) in particular, the present invention relates to an operation device for a graphical user interface (GUI) that senses the user's body motions so that the user utilizes the body motions to operate the graphical user interface.

2. Description of Related Art

The graphical user interface (GUI) is a user interface that uses graphics as the front-end for control operations. It uses a uniform graphic and control operations, such as windows, menu, and cursor, as the interact interface between the user and a computer system. Thereby, even though the user cannot input a direct command to the computer system, the user still can input an instruction to the computer system via the GUI to search and operate the computer functions.

Since 1980, the GUI is considered a mature market, and is applied to a variety of electronic devices, such as desktop computer, laptop, mobile communication device, PDA, and mobile GPS, etc. It is a handy, user-friendly, and rapid operation interface. However, when the user uses the GUI to operate the computer system or interact with the computer system, the user still needs to use a keyboard, a mouse, a touch panel, or other operation device to input the related instruction. It is a limitation for the GUI, and cannot provide a situational operation environment.

Therefore GUI that is operated by detecting the user's body motions is developed. However, the user still needs to uses a specific input device, such as a handle, or a remote control, and the GUI cannot exactly react to the user's specific motion so that the cursor displayed on the computer system or electronic game machine cannot react to the user's body motion sensitively and immediately.

### SUMMARY OF THE INVENTION

One particular aspect of the present invention is to provide an operation device for a graphical user interface (GUI) that senses the user's body motions to operate a corresponding GUI.

The operation device for a graphical user interface includes an image sensing unit and a GUI. The image sensing unit includes an IR lighting device, an image obtaining device, and a calculation control module. The IR lighting device is used for emitting IR to the user. The IR reflected from the user pass through the image obtaining device that forms a photo image to obtain an IR image. The image obtaining device digitalizes the IR image and outputs a digital image signal. The calculation control module is connected with the image obtaining device for receiving the digital image signal so as to identify change of an user image, which is the photo image that represents the user; wherein the change is identified according to a time coordinate axis on a two-dimensional reference coordinate that corresponds to the user's body motions to generate an operation signal.

The GUI is displayed on a display screen and is connected with the image sensing unit for receiving and reacting to the operation signal to display a specific output response.

The present invention has the following characteristics:

1. The image sensing unit of the present invention can exactly identify the user's body image according to the photo image and has an excellent sensitivity.

2. The image sensing unit can perform a calculation to the depth of field of the user's body motions to obtain the user's body dimension or the movements. Thereby, the user can fully utilize the body motions to operate the GUI.

3. The user does not need to use the other input device, such as keyboard, mouse, touch panel, or joystick, etc. The user naturedly involves the situational environment of the GUI and utilizes the body motions to operate the GUI.

4. The present invention can provide a variety of operations for the GUI, including a two-dimensional GUI and a three-dimensional GUI. The virtual simulation effect is versatile.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a block diagram of the operation device for a graphical user interface of the present invention;

FIG. 2 is a schematic diagram of the operation status of the operation device for a graphical user interface of the present invention;

FIG. 3 is another schematic diagram of the operation status of the operation device for a graphical user interface of the present invention;

FIG. 4 is a schematic diagram of the operation status of the operation device for a graphical user interface of the second embodiment of the present invention; and

FIG. 5 is another schematic diagram of the operation status of the operation device for a graphical user interface of the second embodiment of the present invention.

### DETAILED DESCRIPTION OF PREFERRED EMBODIMENTS

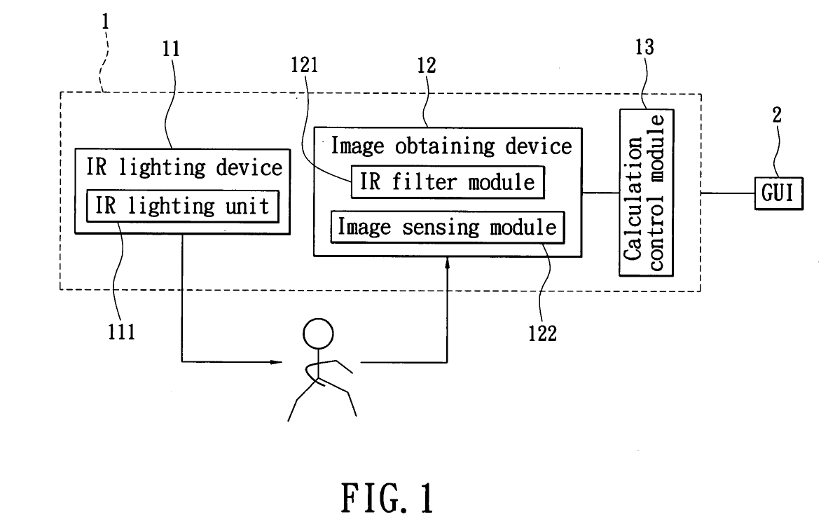

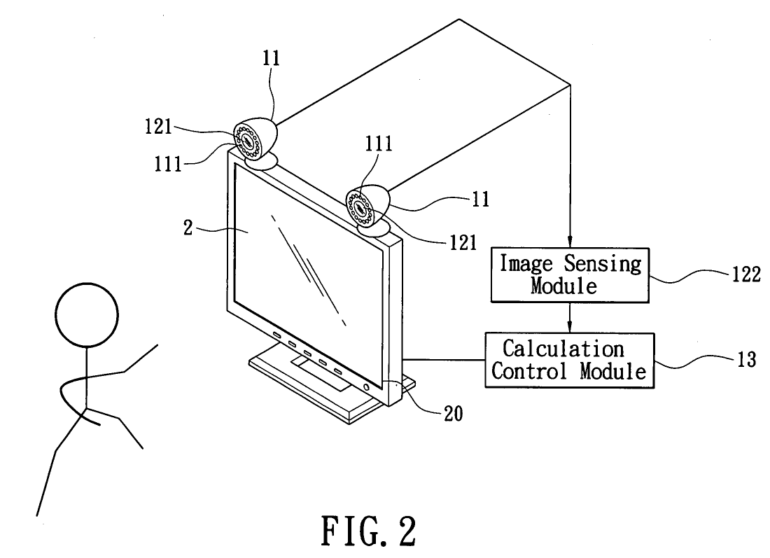

Reference is made to FIGS. 1 and 2, which show a block diagram and a schematic diagram of the operation device for a graphical user interface (GUI) of the present invention. The operation device for a graphical user interface includes an image sensing unit 1 and a GUI 2. The GUI 2 is connected with the image sensing unit 1 and is displayed on a display screen 20.

The image sensing unit 1 includes an IR lighting device 11, an image obtaining device 12, and a calculation control module 13. The IR lighting device 11 is used for emitting IR to the user, and includes a plurality of IR lighting units 111. For example, the LED can emit IR with wavelength between 750 nm and 1300 nm. In this embodiment, the wavelength of the IR is 850 nm. As shown in FIG. 2, the IR lighting device 11 is located on the outside of the image obtaining device 12. The IR lighting units 111 surrounds the image obtaining device 12. In this embodiment, the IR lighting units 111 are disposed in a ring-shape, but not limited to above. The IR lighting units 111 can be disposed in a rectangular shape, or a specific curve shape to emit uniform IR to the user. The IR lighting device 11 can be located above the display screen 20 to emit uniform IR to the user who is operating the GUI 2.

The image obtaining device 12 includes an IR filter module 121 and an image sense module 122. The IR filter module 121 includes a color filter plate for filtering the light that is not within the IR wavelength. The image obtaining device 12 uses the IR filter module 121 to make the IR reflected from the user pass through the image obtaining device 12 and form an photo image, and thereby an IR image is received by the image obtaining device 12. The image sense module 122 receives the IR image, increases the contrast between the photo image that represents the user (a.k.a. the user image) and the environmental background image in the IR image, digitalizes the IR image, and outputs a digital image signal. The digital image signal includes the user image and the environmental background image. In this embodiment, to increase the contrast between the user image and the environmental background image can be implemented by the brightness of the user image being higher than the brightness of the environmental background image, or the brightness of the user image being lower than the brightness of the environmental background image. Alternatively, an auxiliary information is pre-provided. For example, an image reference value is set, and the digital image signal is localized. When the change rate of the localized digital image signal is larger than the image reference value, the user image is set (foreground). When the change rate of the localized digital image signal is lower than the image reference value, the environmental background image is set (foreground). Thereby, the user image is obtained and selected, and the environmental background image is removed to identify the user's body motions.

Because the distance of the user to the image obtaining device 12 versus the distance of the environmental background to the image obtaining device 12 are different, the respective associated depths of field are also different. Therefore, the calculation control module 13 is connected with the image obtaining device 12 for receiving the digital image signal and calculating the depth of filed of the user image in the digital image signal to provide the necessary auxiliary information to remove the environmental background image from the digital image signal. Thereby, once the user image is locked it is tracked so that only the relevant user image is kept, and the subsequent extra image that happens to have the same depth of field as the user image is filtered. Next, the locked user image is defined a two-dimensional reference coordinate and calculated to identify the change of the user image according to a time coordinate axis on the two-dimensional reference coordinate and generate an operation signal corresponding to the user's body motion. As shown in FIG. 2, when two image obtaining modules 12 are connected with the calculation control module 13, the calculation control module 13 receives the digital image signals from different image obtaining modules 12 to calculate and compare the depths of field of the user images to obtain the three-dimensional information of the user's body. Thereby, whether the user's limbs are overlapped can be exactly identified, and the movement or the acceleration of the user to the image sensing unit 1 or the display screen 20 is identified.

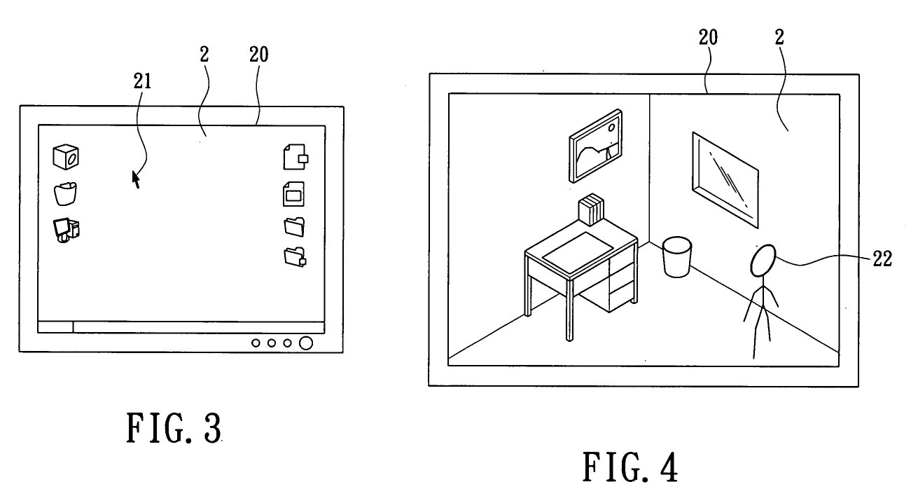

The GUI 2 receives the operation signal generated by the calculation control module 13, and displays a specific output response corresponding to the operation signal. The display screen 20 can be a plane display or a projector screen projected by a projector. As shown in FIG. 3, the GUI 2 can be a two-dimensional graphical operation interface, such as a user interface with windows, icons, frame, menu, and pointer 21. The pointer 21 can perform a specific response to correspond to the user's body motion, such as move upwards, downwards, left and right, and select and open.

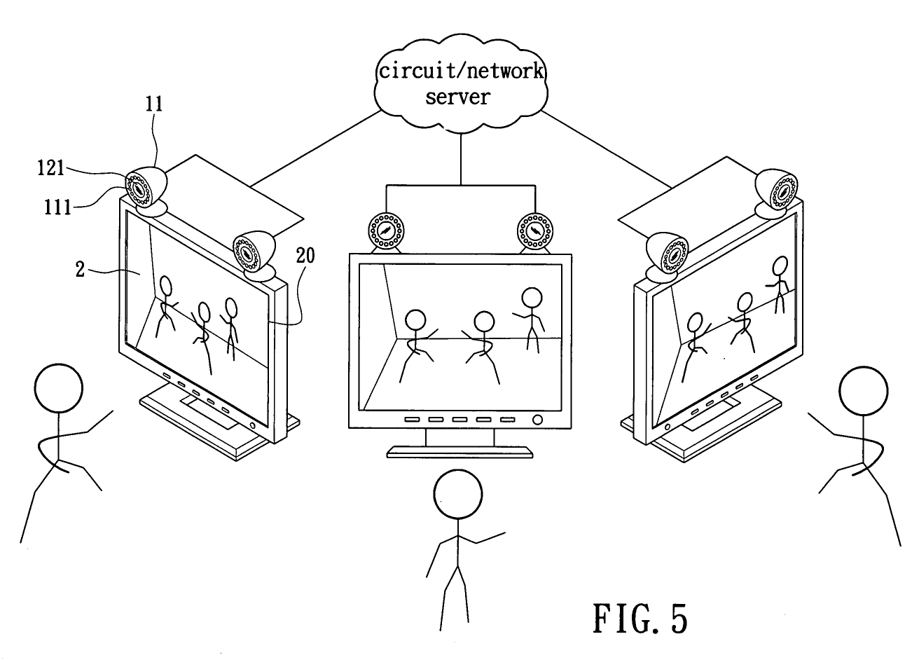

As shown in FIG. 4, in a second embodiment, the GUI 2 also can be a situational operation environment within a virtual reality. In the GUI 2, the object can be displayed as a three-dimensional image. An image pointer 22 for representing the user's body or a specific portion is included to correspond to the user's body motion and is used as a pointer. For example, the image pointer 22 can show a movement or a swing action to correspond to the user's body motion or the limbs swing. Especially, when the user moves forwards or backwards to the image sensing unit 1 or the display screen 20, or the limbs swings (such as the palm hits forwards or boxing), the image pointer 22 corresponding to the user's body motion in the GUI 2 can receive the operation signal generated by the image sensing unit 1 to display a specific output response, such as selecting, clicking, or opening, etc.

In the embodiments, the GUI 2 can display a variety of specific situations, such as living room, meeting, or party, etc. As shown in FIG. 5, a plurality of image sensing units 1 are connected with a computer or a network server to correspond to a plurality of users so that different users can operate the image pointer 22 in the GUI 2 to react to each other. The users will feel immersed in the virtual reality, and the versatile virtual reality effect is achieved.

The present invention has the following characteristics:

1. The image sensing unit 1 of the present invention has an excellent background image filter effect, can exactly identify the user's body image through utilization of depth of field and tracking, and has an excellent sensitivity.

2. The image sensing unit 1 can perform a calculation to the depth of field of the user's body motions to obtain the user's body dimension or the movements. Thereby, the user can fully utilize the body motions to operate the GUI.

3. The user does not need to use the other input devices, such as keyboard, mouse, touch panel, or joystick, etc. The user naturedly involves the situational environment of the GUI and utilizes the body motions to operate the GUI.

4. The prevent invention can provide a variety of operations for the GUI, including a two-dimensional GUI and a three-dimensional GUI. The virtual simulation effect is versatile.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An operation device for a graphical user interface, comprising:
an image sensing unit having an IR lighting device, an image obtaining device, and a calculation control module, wherein the IR lighting device is used for emitting IR to the user, the IR reflected from the user pass through the image obtaining device that forms a photo image to obtain an IR image, the image obtaining device digitalizes the IR image and outputs a digital image signal, the calculation control module is connected with the image obtaining device for receiving the digital image signal so as to identify change of an user image, which is the photo image that represents the user; wherein the change is identified according to a time coordinate axis on a two-dimensional reference coordinate that corresponds to the user's body motions to generate an operation signal; and
a GUI displayed on a display screen and connected with the image sensing unit for receiving the operation signal and displaying a specific output response.

2. The operation device for a graphical user interface as claimed in claim 1, wherein the calculation control module receives the digital image signal outputted from the image obtaining module and calculates a depth of filed of the user image in the digital image signal to provide an auxiliary information to remove the environmental background image from the digital image signal, thereby merely the user image is locked and tracked, and the locked user image is defined a two-dimensional reference coordinate for performing a calculation operation.

3. The operation device for a graphical user interface as claimed in claim 2, wherein the calculation control module filters the image with a depth of field that is the same as the user image.

4. The operation device for a graphical user interface as claimed in claim 1, further comprising a plurality of image obtaining devices, wherein the calculation control module is connected with the image obtaining devices and receives a plurality of digital image signals from the image obtaining devices to compare the difference and change of the depth of filed of the user image in the digital image signals, calculate the location or the dimension in the space of a specific portion of the user's body and identify whether the user's limbs are overlapped or not and the distance, movement, acceleration, and rotation of the user's body to generate the operation signal corresponding to the user body motion.

5. The operation device for a graphical user interface as claimed in claim 1, wherein the GUI includes an image pointer that represents the user's body or a specific portion of the user's body, the image pointer corresponds to the user's body motion and is used as a pointer.

6. The operation device for a graphical user interface as claimed in claim 1, wherein the GUI displays a two-dimensional image or a three-dimensional image.
